(19) United States
(12) Patent Application Publication
(10) Pub. No.: US 2003/0014414 A1
(43) Pub. Date: Jan. 16, 2003

(54) Personcast - customized end-user briefing

(76) Inventor: Bruce D. Newman, Lake Carmel, NY (US)

Correspondence Address: CARL C. KLING, P O BOX 305, HAWTHORNE, NY, 10532-0305, US

(21) Appl. No.: 09/732,147

(22) Filed: Dec. 7, 2000

(51) Int. Cl. G06F 17/30; G06F 7/00

(52) U.S. Cl. 707/10

(57) ABSTRACT

Originators of newsletters, market research, scientific facts, discussions, encyclopedias, etc. may elect to avoid the effort of managing and sending this information directly. This invention offers a subscription service for management and delivery of a customized, formatted, document containing information selected to specified user preferences. Delivery is via e-mail through the user's internet service provider. The customized document may appear to have come directly from the subscriber originator. The number of articles in the document, along with the frequency by which it is automatically generated, is determined by the service, contract with the subscribing originator. Furthermore, by maintaining a translation/addressing conversion mechanism at the level of the Internet service provider, all user preferences and anonymity are preserved. The invention also may offer a truncated version of its customized document for transmission to a PDA.

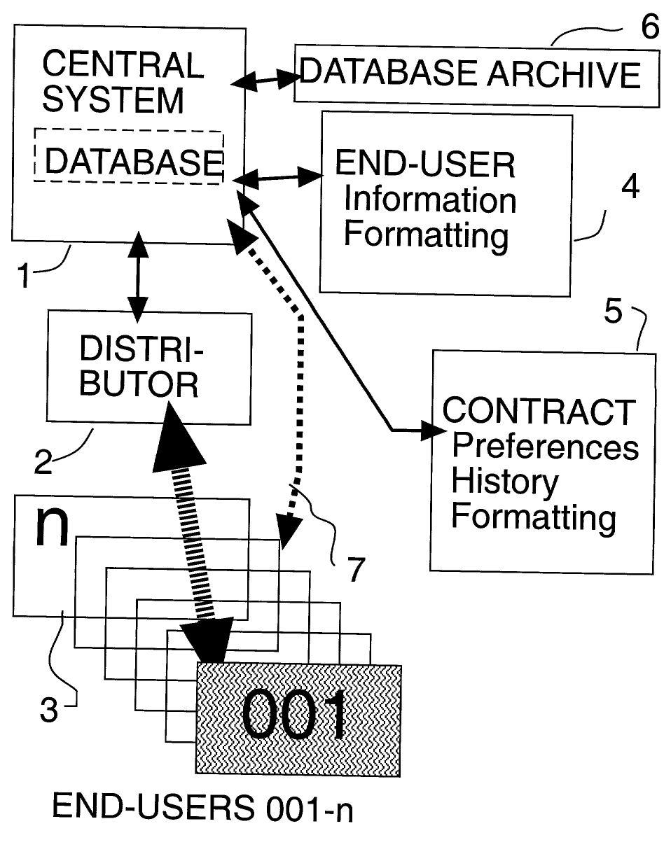

### CROSS-REFERENCE TO RELATED APPLICATIONS

(None)

### STATEMENT REGARDING FEDERALLY SPONSORED RESEARCH OR DEVELOPMENT

(None)

### REFERENCE TO A MICROFICHE APPENDIX

(None)

### BACKGROUND OF THE INVENTION

(1) Field of the Invention

This invention relates to end-user directed document presentation over a transmission channel, and more particularly relates to a method of computerized selection and selective abridgment of electronically stored documents received from publishers and transmitted to an end-user or distributor as a timely, personalized electronic clipping service.

(2) Description of Related Art

Communication by handwritten direct mail is a “personcast”—a communication specially directed to an individual or group of individuals and specifically configured by the sender to meet the mutual requirements of sender and end-user(s).

During the age of printing on paper, which still continues, there arose postal systems for delivery of information by both direct mail and general circulation newspapers. Such a newspaper is the New York Times, whose slogan was and continues to be “All the news that's fit to print.” The complexity of such newspapers is such that they typically have standard sections (i.e. Sports), subsections and often include a Table of Contents and/or an Index. The reader is also directed by headlines and bylines and in most news stories in the majority of newspapers, by the habitual use of a lead paragraph of about 30 words following the journalistic mantra of “who-what-when-where.” The reader, after viewing the headline and byline and reading the lead paragraph, typically has enough information to determine whether to read or skip the rest of the article. Scientific journals are even more rigorous, generally demanding headline and byline plus an abstract. As the amount and complexity of information rapidly increased, people looked for both the speed and ease in determining what and how much to read; the Readers Digest became a runaway success in the early middle years of the twentieth century with its abridgments of articles in popular magazines.

With the rapidly increasing population, the volume of news also increased with the result being that general-circulation newspapers have now been supplanted or supplemented by special-interest newspapers such as the Wall Street Journal and TV Guide. This has in turn led to the development of the individually directed newsletter.

As the Internet continues to develop, the use of newsletters for information, marketing and advertising purposes has grown exponentially. Their extremely low cost per issue coupled with the “free” delivery or transmission to subscribers has resulted in this incredible and accelerating growth. Fully 75% of the newsletters now available on the Internet are less than one year old with an expected number of newsletters being in excess of 300,000 by 2002.

In addition to newspapers and newsletters, corporate executives have tended to expect their executive assistants and others to provide executive summaries of long documents and to provide clipping services for use by the executives with a minimum expenditure of executive time. Carried to the maximum, the executive assistant provides a “briefing” to the executive of selected short items abridged or extracted from numerous publications. Even at the family level, one spouse might point out certain items of interest to the other.

During the rise of the electronic age, television has become the primary news communication because of its obvious speed and cost advantages of electronic broadcasting and the fact that people like the speed of the video/audio presentation. Severe time constraints, however, have led to a type of headlines-only news presentation, with details, if any, cut down to the equivalent of a briefing. Headlines and details are selected at the TV network or at the local TV station, to appeal—generally as briefings—to their target audiences. The printed word has become the detailed backup and the archive.

The Internet appears to have most of the broadcast advantages of TV and most of the detailed backup and archive advantages of print. It can reach a huge audience with pertinent, timely information usually in the form of a newsletter. Furthermore, this information can be directed towards a specifically targeted (and usually opt-in) audience. The major problem, however, is this rapidly increasing quantity of available documents and information. With literally thousands of special-interest newsletters available on a daily or weekly basis, even the most sophisticated database systems and search engines are unable to provide a quick briefing of key articles to an individual person—and are not designed to do so. Since their emphasis is primarily directed towards web sites and web pages, their data retrieval and indexing is based upon the static content of the site—not the rapidly changing content of that site's information, newsletters and publications. This helps explain the often enormous (and largely un-useful) number of documents found when searching for particular topical information. Even the most computer-sophisticated individual may be unable to locate the timely and most pertinent articles he or she seeks given the sheer volume of information available in this rapidly changing world. Coupled with the limited time most people have today to even read this information, the need for brief targeted articles (consisting of a headline and lead paragraph or abstract) is rapidly increasing.

A Personcast briefing set is designed to address this need. This briefing set consists of a communication specially directed to an end-user or group of end-users, based on their search criteria. The resulting matching documents—written by their publishers—that meet these search criteria will then be inserted formatted in a template and transmitted to that end-user or group of end-users. These documents that are searched will be primarily newsletters and various text sources of information.

In practice, the publisher writes, the clipping service selects according to pre-specified criteria and distributes to the end-user.

### GLOSSARY OF TERMS

Distributor—either ISP's (Internet Service Providers), ASP's (Application Service Providers) and medium to large companies, all of whom are subscribers to the service

End-user—individual who receives the briefing set

Briefing set—refers to the formatted information the end-user receives

Document—a writing that contains information

Publisher—the originator of information to be placed in a database and retrieved and

inserted into a template to help form a briefing set

Template—contains the formatting and header directions utilized in the creation of the briefing set.

Abstract—an author prepared short statement of information

Abridgement—a shortened version of a written work

Truncated document—an abruptly shortened version of a written work, usually at some specified word count

Personcast—briefing set directed at an individual person or group of persons

### BRIEF SUMMARY OF THE INVENTION

It is the object of the invention to provide a novel software and business solution so that an Internet newsletter publisher will supply documents appropriately formatted and without restriction to the end-user. (Pay-documents can also be supplied as an abstract or in abridged format). The personcast constructs and directs appropriate combinations of these articles of information as a briefing set to the user.

A feature of the invention is to prepare a personcast for an end-user which can be sent either directly to that end-user or to a distributor. The distributor can in turn send this briefing set to the end-user or to a subset of end-users, thereby expanding the range of the transmission. Using this method of distribution, the distributor can also protect the identity and preferences of the end-user(s).

Other objects, features and advantages of the invention will be apparent from the following written description, claims, abstract and the annexed drawings.

### BRIEF DESCRIPTION OF THE SEVERAL VIEWS OF THE DRAWING

The FIGURE shows the invention schematically as a box diagram.

### DETAILED DESCRIPTION OF THE INVENTION

This invention, Personcast, relates to the information currently available on the Internet. With the enormous and rapidly expanding amount of information comes the need for each end-user to easily access those areas of information that he or she deems relevant. The need for this system is particularly noticeable when coupled with the rapid increase in the number and frequency of newsletters currently being published on the Internet.

Personcast is comprised of the following parts: the ability of the end-user to make customized selections by topic and subtopic, the ability to search and gather the requested information and format it into the distributor's template, the ability to add advertising to each returned newsletter and to selectively lock out advertising in certain categories and the ability to minimize the amount of returned text in order that it can be transmitted to a PDA (i.e. hand-held computer or e-mail enabled wireless telephone). Personcast will automatically supply a briefing set containing timely information on an individual basis to every end-user or subset of end-users. This will occur on a scheduled basis or upon authorized request. This customized briefing set differs greatly from the output of a search engine or portal since it is much more specific in targeting articles of information, the amount of information returned and the formatting of the returned document. Instead of returning potentially millions of articles in a list that must then be individually accessed, Personcast will automatically supply a pre-determined number of relevant and timely (mostly newsletter) articles in a predetermined format—i.e. the briefing set. While it might use some existing information search technology, all of its other components differ greatly from all existing search engine technologies and services.

Summary of the Personcast

Pertaining mostly but not exclusively to newsletters, the rapidly increasing amount of information available on the Internet and limited amount of time available in most people's day makes it almost impossible to keep up with new information and relevant discussions in one's relevant area. Search engines are limited in how they can help since a standard search will frequently return hundreds of thousands of potential matches, often to Web sites that are not even relevant to the topic of the search. In any case, most research shows that only the first few pages of matches returned by search engines are routinely accessed.

Personcast is designed to allow the end-user to specifically request recent articles from a variety of topics and subtopics. This list of topics will rapidly evolve and will allow an end-user to target various areas of interest. By maintaining a database of end-user preferences as well as categorizing information by both content and topics, a large indexed database will rapidly grow. Data from this database will be frequently and rapidly retrieved (without changing the text) and inserted into the appropriate template. The search for this information will be performed by several methods including standard search algorithms and via an index key based on the topic/sub-topic categorization. It is this breakout of information plus feedback from the end-user and/or distributor that will permit the accurate retrieval and formatting of specific and timely information.

Furthermore, Personcast will not only automatically format the requested information, but also add or exclude advertisements. The formatting of the returned information will be performed using several—possibly customized templates with the option of permitting distributors to modify the header, imbed graphics or append text to the briefing set.

Personcast will also be the ability to format a limited amount of the returned information so that it can be sent via e-mail to a hand held device (i.e. a PDA which also includes a wireless hand held e-mail enabled telephone).

The Selection Criteria

A list of topics and subtopics will be presented to the end-user as he or she accesses the Personcast system. The end-user will be able to select each topic, subtopic and/or keyword. By clicking on a topic, the end-user causes a list of subtopics to appear. Additional subtopics can appear automatically or by additional mouseclicks, depending upon the subtopic selected. Multiple subtopics can be selected. The end-user can also request that a new subtopic be added to the list, either for personal use or, if accepted by a screener, for common use. Upon selection, the list of selected subtopics and keywords will be sent to the Personcast central system database for storage under that user's preferences. This allows for the creation of a history record of that end-user's preferences and selections. This record can be modified by the end-user at any time.

In a typical instance, the end-user will rank the newsletters (via categories and subcategories) that he or she wants to receive as well as by certain keywords for the Personcast system to look for in the targeted articles. This stored personal preference information will enable Personcast to provide the end-user with customized downloads in the future. In the case that the end-user wants an update on the same topics, articles or keywords, he/she will not have to again go through this selection process. If the end-user wishes a change, the entire selection process is laid out to make changes easy.

The Personcast central computer will in turn present the end-user with a list of criteria-matching newsletter articles along with possibly other types of article information retrieved either from the Personcast database or from an external source. Each article or information type is presented by title and its first few lines. An abstract or part of an abstract may also be presented, if available. These articles or abstracts are presented to an end-user within a briefing set after being inserted into a pre-defined template.

The Operational Database

The operational database will contain information on end-user preferences, history and keywords. The operational database will also contain the list of topics and subtopics that are presented to the end-users. The operational database will utilize a standard search engine that will create multiple indexes and help organize the rapidly growing amount of search operation control sequences for rapid access to updated information. Finally, the operational database will also cross-index the newsletters and information sources with various topics and sub-topics as determined by the publishers of the participating newsletter publishers. Participating publishers opting to be included within the Personcast system will be required to periodically select those topics and subtopics relevant to them.

The operational database will also store most of the information (consisting primarily of newsletters but also including other types of documents) that will be searched and retrieved. Most of these documents will reside on a large hard disk, distributed hard disks and/or on optical storage. Additional remote storage and retrieval of information may also be required (and/or offered) in the future as well as the access of hard disks from other locations. Since the number of documents that are stored in the operational database will rapidly and frequently increase, constant indexing and data categorization and subcategorization is a necessity.

The Briefing Set

The Personcast briefing set will contain identification such as date, title and author as well as a small amount of the unchanged text from the original article. In most cases, it will also contain a link to the original web site from which the document originated. Depending on the length and number of articles, the article may be truncated at some pre-determined length. These articles will be formatted according to a specific template and transmitted in either text or HTML format. The optional attachment of header information will automatically be accomplished according to the design parameters of the template.

Depending on the contract with the distributor, the Personcast briefing set can also include specially tailored features. A category lockout will also be employed to ensure that competing companies are not forced to include a competitor's advertising. This category lockout will utilize the topic/sub-topic selection discussed above, and may contain an end-user override, although unlikely.

Transmission of the Personcast End-User Briefing

The Personcast System will be useful primarily to medium to large companies, ISPs (Internet Service Providers) and ASPs (Application Service Providers)—all three being designated as “Distributors”, to add a value-added service for their employees, members or clients. These Distributors will contract for the inclusion in the Personcast System and will be charged a fee for the service depending on a number of criteria. This fee will in part be based on the number of articles in the newsletter document, the frequency of publication, whether or not it contains advertising and the amount of advertising if it does and the total number of newsletter documents to be supplied by Personcast as the Personcast End-user-Briefings over a predetermined period of time. All End-user Briefing documents are supplied by Personcast and can be sent either directly to the end-user or to the Distributor via e-mail. The Distributor can then rout these briefing set documents to the requesting end-user(s). While Personcast will have the capability for e-mail broadcast directly to the distributor or end-user(s), by utilizing the resources of the Distributor, Personcast can ensure the anonymity of its service. In this manner, the Distributor will appear to be providing a value-added service to its clients and employees. A Distributor application module, which interfaces with the Personcast, will also be made available to ASPs who want to include it with their systems and applications.

The Personcast will be designed to work with the Distributors, who maintain anonymity of their clients and employees by utilizing a translation table for the addresses of their end-users. In this case, the actual unique ID of each end-user will be translated by the Distributor and a unique code name generated. This will work with messages directed both to and from the end-user by Personcast, with only the decoding and re-coding of addresses performed by the Distributor. Since Personcast will only know the code name, it will not be privy to the actual end-user names and their corresponding e-mail addresses.

The PDA Personcast

Since the targeted Personcast Briefing provided by Personcast is sent via email to the Distributor (and by the Distributor to the end-user(s)), the Personcast Briefing can also be constructed in order that it can be e-mailed to any PDA device including wireless e-mail and/or Internet capable hand held devices and telephones. This automatic modification will require the truncating of the article to include only the heading and the first few words. It can also include the counting of the number of letters or words to be transmitted. Since this is an automatic process, to determine the actual contents of the article and automatically create a summary cannot be done by this system. A title and one line summary, if supplied, will also accomplish this function. This truncated text will then be e-mailed to the appropriate host for transmission to the end-user's PDA.

Personcast will be available to any subscribing ISP, ASP or company. It will automatically distribute a set of customized briefing sets for each distributor, distributor's end-user or set of end-users at pre-determined regular intervals or upon special request, the latter depending on the distributor's contract.

The frequency and number of articles contained in this template will be determined by the contract with the distributor.

The structure and design of the template, though standardized, can also be modified to meet the specifications and requirements of a distributor.

The articles within the briefing set will be automatically selected based on each individual's preference or on the specific topics and subtopics list as specified by the distributor. In this case, briefing sets will most likely be directed towards individuals or subsets of individuals.

These individual preferences will be based upon the selection of topics/subtopics and keywords from an interactive page supplied by each individual end-user.

The newsletter document will automatically be formatted with some predetermined template and will be supplied in either text or HTML format. This template may also include the automatic addition of a distributor's header information.

Limited advertising can also be included in the document based on the contract with the distributor.

A category lockout list based on topic/sub-topic criteria will also be available to advertisers.

The briefing set document will be e-mailed directly to the distributor who will then access the user ID and then send it to that specific end-user to preserve his/her anonymity and their personal preferences. The briefing set can also be emailed directly to the end-user.

Decoding of a user's ID will be done through the use of a translation table at the developer's site.

Personcast will automatically record all end-users preferences.

Categorization/sub-categorization selections will be offered and frequently updated in addition to the creation of an end-user-based rating system for articles and authors.

A rapidly growing database will contain many articles and documents that can rapidly be retrieved. This database will maintain author and publication information, which will also be included, as a link in the documents retrieved for the end-user.

This database will be frequently indexed and categorized.

The information will be made available to companies capable of transmitting information to PDAs. This information will be filtered to a few sentences to reduce the size of the transmission.

1. A system for preparing and distributing individually customized information to end-user end-users, characterized by:
central system operational database means for storing operational master lists of advertisers, publishers, distributors and end-users, for storing a super-list of topics, sub-topics and sub-sub-topics, and for storing current and archive selection criteria;
central system master database means for storing an updated superset of documents formatted with keywords, index, topic and content identification arranged so that said keywords, index, content and topic identification is effective in accessing related items from said stored documents;
central system personalization means for distributing an operational master list to a end-user and for receiving the end-user's working list as a briefing of selection and sequencing of index, content and topic identifications by the individual end-user;
central system means for storing end-user preference, advertising lockout and working list information and for querying said central system master database means according to said central system operational means and for developing Personcast briefing sets individualized to the end-user; and
transmission means for sending said Personcast briefing sets individualized to the end-user to the appropriate end-user via a Distributor.

2. A system according to claim 1, further characterized in that said central system operational means, central system database means and central system personalization means are adapted to develop and transmit a briefing set for communication to the user.

3. A system according to claim 1, further characterized in that said central system operational means, central system database means and central system personalization means is adapted to develop and transmit a briefing set for communication to a distributor for further transmission to a set of end-users.

4. A system according to claim 1, further characterized in that said central system operational means, central system database means and central system personalization means is adapted to develop and transmit a briefing set for communication to a distributor for further transmission to a subset of end-users.

5. A system according to claim 1, further characterized in that said central system operational means, central system database means and central system personalization means is adapted to develop and transmit a briefing set for communication to a distributor for further transmission to an individual end-user.

6. A system according to claim 5, further characterized in that said central system operational means, central system database means and central system personalization means are adapted to store a record, by individual end-user, of briefing sets developed for communication to a distributor for further transmission to an individual end-user.

7. A system according to claim 6, further characterized in that said central system operational means, central system database means and central system personalization means are adapted to store a record, by individual end-user, of briefing sets developed for communication to a distributor for further transmission to an individual end-user, and to consider such stored record in developing a further briefing set for such individual end-user.

8. A system according to claim 7, further characterized by means to accept feedback from the individual end-user to alter said stored record of preferences for briefing sets to be developed.

9. A system according to claim 8, further characterized in that said central system operational means, central system database means and central system personalization means are adapted to consider such record, by individual end-user, in adding advertising copy to further briefing sets developed for communication to a distributor for further transmission to an individual end-user.

10. A system according to claim 4, further characterized in that said central system operational means, central system database means and central system personalization means are adapted to develop a record and consider such record, by end-user sub-set, in directing advertising copy to further briefing sets developed for communication to a distributor for further transmission to such end-user sub-set.

11. A system according to claim 1, further characterized in that said central system operational means, central system database means and central system personalization means are adapted to consider such record, by individual end-user, in directing advertising copy to further briefing sets developed for communication to a distributor for further transmission to an individual end-user.

12. A system according to claim 11, further characterized in that said central system operational means, central system database means and central system personalization means are adapted develop a record of advertising parameters, such as source and type, and to consider such parameters in directing advertising copy to further briefing sets developed for communication to a distributor for further transmission to an individual end-users, locking out advertising.

13. A system according to claim 11, further characterized in that said central system operational means, central system database means and central system personalization means are adapted to develop a record of advertising parameters, such as source and type, and to consider such parameters in directing advertising copy to further briefing sets developed for communication to a distributor for further transmission to a subset of end-user, locking out advertising according to such advertising parameters.

14. A system according to claim 1, further characterized in that said central system operational means, central system database means and central system personalization means are adapted to develop a record of end-user equipment parameters, such as limited viewscreen, and to consider such parameters in developing further briefing sets developed for communication to users having limited viewscreen capability, such as PDA users.

15. A system according to claim 1, further characterized in that said central system operational means, central system database means and central system personalization means are adapted to develop a record of end-user personal parameters, such as language preference or poor eyesight, and to consider such parameters in developing further briefing sets developed for communication to users having limited viewscreen capability.

16. A system according to claim 1, further characterized in that said central system operational means, central system database means and central system personalization means are adapted to develop a record of end-user preference parameters, such as format or abridgment, and to consider such parameters in developing further briefing sets developed for communication to users having limited viewscreen capability, such as PDA users.

17. A system according to claim 1, further characterized in that said central system operational means, central system database means and central system personalization means are adapted to develop a record of end-user preference parameters, such as e-mail backup, and to consider such parameters in developing further briefing sets developed for communication to such users.

18. A system according to claim 1, further characterized in that said central system operational means, central system database means and central system personalization means are adapted to develop a record of distributor preference parameters, such as number of items and abridgment, and to consider such parameters in developing further briefing sets developed for communication to such users.

19. A system according to claim 1, further characterized in that said central system operational means, central system database means and central system personalization means are adapted to identify all end-user records only by cypher known to the system and the internet service provider, keeping identification of end-user secure.

20. A system according to claim 1, further characterized in that said central system operational means and central system database means are adapted to accept information packets from source providers and to retain such information packets according to information source provider contract.

21. A system according to claim 20, further characterized in that said central system operational means and central system database means are adapted to accept information packets from source providers and to retain such information packets, according to information source provider contract, for a limited period of time.

22. A system according to claim 20, further characterized in that said central system operational means and central system database means are adapted to accept information packets from source providers and to retain such information packets, according to information source provider contract, for a limited period of time, followed by archiving.

23. A system according to claim 22, further characterized in that said central system operational means and central system database means are adapted to accept information packets from source providers and to retain such information packets, according to information source provider contract, for a limited period of time, followed by archiving, and to query the archive to supply a briefing set upon request only.

24. A system according to claim 1, further characterized by a newsletter distribution system in which the newsletter source provider provides copy for the complete newsletter for a first subscriber list, and said system is available for distribution to public users according to arrangements with the system provider.
